(19) United States
(12) Patent Application Publication
(10) Pub. No.: US 2015/0134306 A1
(43) Pub. Date: May 14, 2015

(54) CREATING UNDERSTANDABLE MODELS FOR NUMEROUS MODELING TASKS

(71) Applicant: International Business Machines Corporation, Armonk, NY (US)

(72) Inventors: Pascal Pompey, Nanterre (FR); Mathieu Sinn, Dublin (IE); Olivier Verscheure, Dunboyne (IE); Michael Wurst, Stuttgart (DE)

(73) Assignee: International Business Machines Corporation, Armonk, NY (US)

(21) Appl. No.: 14/079,170

(22) Filed: Nov. 13, 2013

(51) Int. Cl. G06N 7/00

(52) U.S. Cl. CPC G06N 7/00
USPC 703/2

(57) ABSTRACT

A computer program product for creating models comprises a computer readable storage medium having stored thereon first program instructions executable by a processor to cause the processor to receive the modeling tasks each having a target variable and at least one covariate, the target variable and the at least one covariate being the same for all of the modeling tasks, a relationship between the target variable and the at least one covariate being different for all of the modeling tasks, and second program instructions executable by the processor to cause the processor to generate, for each of the modeling tasks, a model including a transfer function for approximating the relationship between the target value and the at least one covariate of the modeling task in a manner that at least two of the models share an identical transfer function and the models satisfy an accuracy condition.

### BACKGROUND

The present invention relates to statistical modeling, and more specifically, to creating understandable statistical models for a large number statistical modeling tasks.

### SUMMARY

According to one embodiment of the present invention, a computer program product for creating models for a plurality of modeling tasks comprises a computer readable storage medium having stored thereon first program instructions executable by a processor to cause the processor to receive the modeling tasks each having a target variable and at least one covariate, the target variable and the at least one covariate being the same for all of the modeling tasks, a relationship between the target variable and the at least one covariate being different for all of the modeling tasks, and second program instructions executable by the processor to cause the processor to generate, for each of the modeling tasks, a model including a transfer function for approximating the relationship between the target value and the at least one covariate of the modeling task in a manner that at least two of the models share an identical transfer function and the models satisfy an accuracy condition.

According to another embodiment of the present invention, a system for generating models for a plurality of modeling tasks comprises a processor configured to receive the modeling tasks each having a target variable and at least one covariate, the target variable and the at least one covariate being the same for all of the modeling tasks, a relationship between the target variable and the at least one covariate being different for all of the modeling tasks, and generate, for each of the modeling tasks, a model including a transfer function for approximating the relationship between the target value and the at least one covariate of the modeling task in a manner that at least two of the models share an identical transfer function and the models satisfy an accuracy condition.

According to yet another embodiment of the present invention, a method for generating models for a plurality of modeling tasks comprises receiving, with a processing device, the modeling tasks each having a target variable and at least one covariate, the target variable and the at least one covariate being the same for all of the modeling tasks, a relationship between the target variable and the at least one covariate being different for all of the modeling tasks, and generating, for each of the modeling tasks, a model including a transfer function for approximating the relationship between the target value and the at least one covariate of the modeling task in a manner that at least two of the models share an identical transfer function and the models satisfy an accuracy condition.

Additional features and advantages are realized through the techniques of the present invention. Other embodiments and aspects of the invention are described in detail herein and are considered a part of the claimed invention. For a better understanding of the invention with the advantages and the features, refer to the description and to the drawings.

### BRIEF DESCRIPTION OF THE SEVERAL VIEWS OF THE DRAWINGS

The subject matter which is regarded as the invention is particularly pointed out and distinctly claimed in the claims at the conclusion of the specification. The forgoing and other features, and advantages of the invention are apparent from the following detailed description taken in conjunction with the accompanying drawings in which:

FIG. 1 is a schematic diagram of a modeling system for building models according to an embodiment of the invention.

FIG. 2 is an example hierarchy of transfer functions that is built according to an embodiment of the invention.

FIG. 3 is a flow diagram of a method in accordance with an embodiment of the invention.

FIG. 4 is a set of models built and modified in accordance with an embodiment of the invention.

FIG. 5 is a flow diagram of a method in accordance with an embodiment of the invention.

FIG. 6 is a schematic diagram of a modeling system for building models according to an embodiment of the invention.

FIG. 7 is a flow diagram of a method in accordance with an embodiment of the invention.

FIG. 8 is a set of models built in accordance with an embodiment of the invention.

### DETAILED DESCRIPTION

Having an understandable set of statistical models for a large number of statistical modeling tasks is desirable for many practical scenarios. For instance, a utility company may want to forecast energy load for each of the company's 800,000 substations in different locations. The utility company may create a statistical model for each of the substations. These models may be related in that they use the same type of covariates, e.g., local weather conditions, time of day, etc. However, the relationship between the covariates and the target variable (i.e., the energy load) may be different for each of the 800,000 models. In order to understand these 800,000 different models, the utility company may have to inspect the 800,000 models individually. Inspecting this large number of models individually is a challenging task.

For a typical model, each covariate (also referred to as an input variable) of the model is associated with a transfer function that transforms the covariate values into the target variable (also referred to as an output variable) values. That is, the transfer function approximates the relationship between the covariate and the target variable. In the utility company example, if each of the substation has ten common covariates, there will potentially be 8,000,000 (800,000 times 10) different transfer functions. This multiplies the complexity of understanding the 800,000 models, which already is a challenging task.

An embodiment of the invention provides a method of building models for a large number of related, but not identical, modeling tasks. In an embodiment of the invention, the modeling tasks are considered related when the tasks have the same number of covariates and the types of the covariates are the same. The related modeling tasks are considered not identical when the relationship between the covariates and the target variable is different for each modeling task. The method in one embodiment of the invention builds the models by reducing a large number of different transfer functions over all models into a more manageable number of transfer functions while maintaining a certain level of accuracy. For instance, for the utility company example discussed above, the method will reduce the number of different transfer functions from 8,000,000 to 400 while maintaining the accuracy of the 800,000 models within a certain threshold error value.

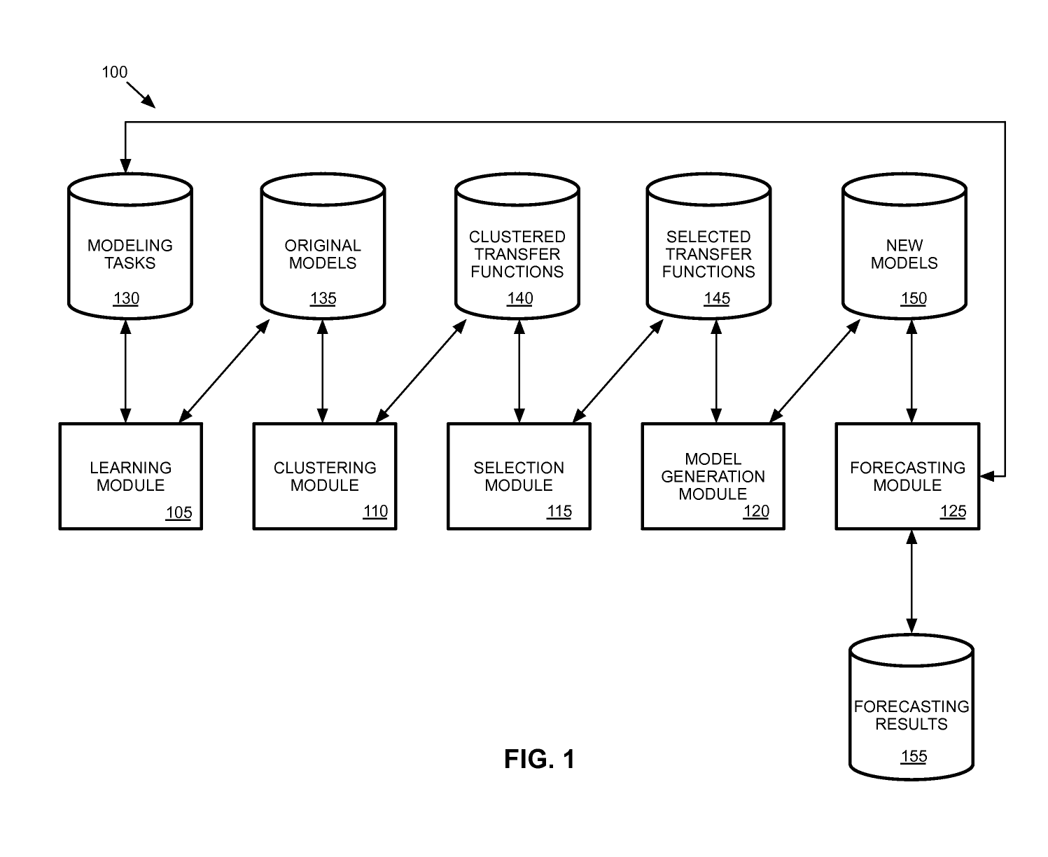

FIG. 1 is a schematic diagram of a modeling system 100 for building models according to an embodiment of the invention. As shown, the system 100 includes a learning module 105, a clustering module 110, a selection module 115, a model generation module 120, and a forecasting module 125. The system 100 also includes modeling tasks 130, original models 135, clustered transfer functions 140, selected transfer functions 145, new models 150, and forecasting results 155.

The modeling tasks 130 include sets of time series data. Each set of time series data represents the values of a target variable observed over a period of time. A modeling task also includes the values of input variables observed over the same period of time. The system 100 builds models that may be used for forecasting future values of the target variable based on these previously observed values.

The learning module 105 analyzes the modeling tasks 130 to learn the original models 135. Each of the original models 135 may be used for forecasting the values of the target variable of a modeling task 130. The learning module 105 may employ one or more known modeling techniques (e.g., regression modeling, ARIMAX modeling, etc.) to learn the original models 135. In one embodiment of the invention, a learning module 105 analyzes the modeling tasks 130 by utilizing an Additive Model (AM) equation, which may look like:

$$Y = {\sum }_{i = 1}^{I} X {1}_{i} + {\sum }_{j = 1}^{J} {f}_{j} ( X {2}_{j} \vert {C}_{j} ) + {\sum }_{k = 1}^{K} {g}_{k} ( X {3}_{k} , X {4}_{k} \vert {C}_{k} )$$

where Y is the target variable; I, J and K are positive integers; X1₁ through X1₁, X2₁ through X2_{J}, X3₁ through X3_{K} and X4₁ through X4_{K} are covariates; the functions ƒ₁ through ƒ_{J} and g₁ through g_{K} are transfer functions for transforming covariate values into target variable values; C₁ through C_{K} are the conditions indicating whether the corresponding transfer functions are active or not for a given data point. Also, X3ₖ and X4ₖ represent a combination of two covariates that could be inputs to transfer functions gₖ's; k is an index number for a combination of covariates; and X1's, X2's, X3's, X4's and Y are functions of time and have different values for different modeling tasks.

For the simplicity of description, the above model equation has only those transfer functions that take one covariate or a combination of two covariates as inputs. However, the equation may include additional transfer functions that may take a combination of three or more covariates as inputs. Moreover, the equation may not include transfer functions that take a combination of two covariates as an input (e.g., transfer functions g₁ through g_{K} may not be part of the model equation). Furthermore, the equation may not include the covariates that are not associated with transfer functions (e.g., X1₁ through X1₁).

Each of the modeling tasks may be represented in an equation:

$${Y}_{h} ≅ {\sum }_{i = 1}^{I} X {1}_{i , h} + {\sum }_{j = 1}^{J} {f}_{j , h} ( X {2}_{j , h} \vert {C}_{j , h} ) + {\sum }_{k = 1}^{K} {g}_{k , h} ( X {3}_{k , h} , X {4}_{k , h} \vert {C}_{k} )$$

where h is an index identifying a modeling task and Yₕ represents an actual data value of the target variable in the modeling task. The learning module learns an original model for each of the modeling tasks by solving the following optimization problem:

$$min ( {‖ {Y}_{h} - ( {\sum }_{i = 1}^{I} X {1}_{i , h} + {\sum }_{j = 1}^{J} {f}_{j , h} ( X {2}_{j , h} \vert {C}_{j , h} ) + {\sum }_{k = 1}^{K} {g}_{k , h} ( X {3}_{k , h} , X {4}_{k , h} \vert {C}_{k} ) ) ‖}^{2} - {Pen}_{h} )$$

where Penₕ is a penalization that controls the smoothness of the model being learned.

Assuming that there are M (a positive integer) modeling tasks 130, there may be as many as M×(J+K) different transfer functions for the M models 135. Each of the transfer functions may be uniquely identified by (1) the covariate(s) associated with the transfer function and (2) the modeling task from which the model is learned. For instance, a transfer function for a covariate X1₇ for a modeling task 8 may be identified as ƒ_{7,8} (X1₇|C_{7,8}). Likewise, a transfer function for a combination 6 of two covariates (e.g., covariate X3₁ and X4₁) for a modeling task 3 may be identified as g_{6,3} (X3_{6,3}, X4,_{6,3}|C₆).

The clustering module 110 groups the transfer functions of the original models 135 into the clusters of similar transfer functions. In particular, the clustering module 110 in an embodiment of the invention builds a hierarchy of clusters for the transfer functions that are associated with the same covariate or the same combination of covariates. The clustering module 110 builds such hierarchy for each of the transfer functions in a model equation. For instance, for the model equation described above, the cluster module 110 may build J+K hierarchies for the J+K transfer functions ƒ₁ through ƒ_{J} and g₁ through g_{K}.

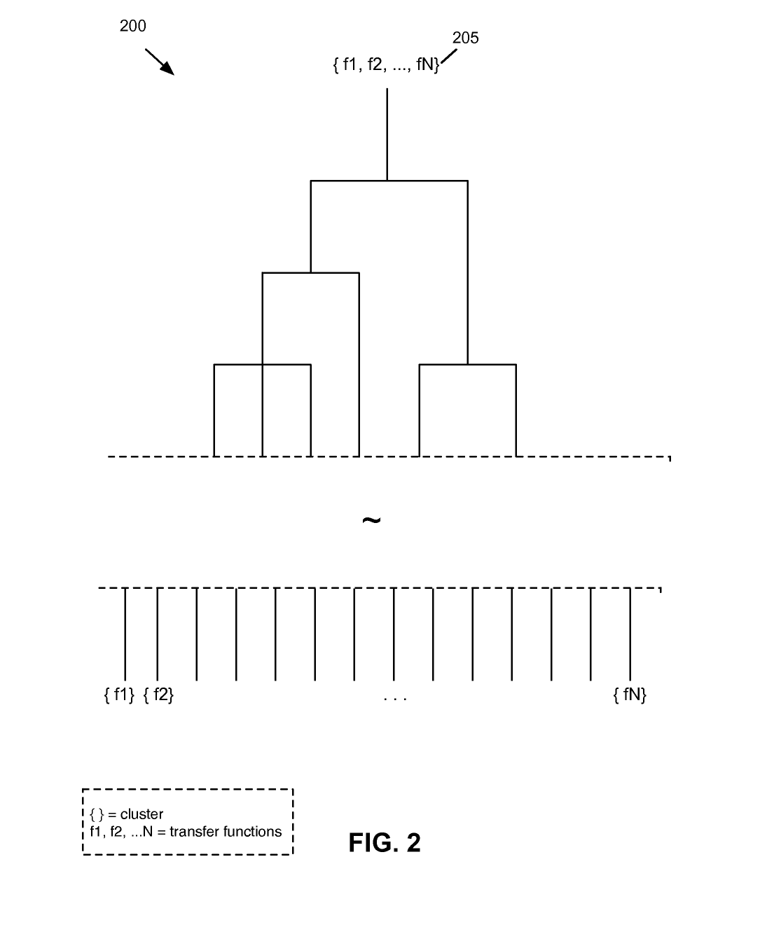

In an embodiment of the invention, the clustering module 110 employs one or more known clustering techniques (e.g., agglomerative, divisive, etc.) to build a hierarchy of clusters. FIG. 2 illustrates an example hierarchy of clusters of transfer functions 200 that the cluster module 110 builds. The hierarchy of clusters 200 may be viewed as a tree where the smaller clusters merge together to create the next higher level of clusters. That is, at the top of the hierarchy is a single cluster 205 that includes all of the different transfer functions associated with the same covariate or the same combination of covariates. At the bottom of the hierarchy 200, there are as many different clusters as the number of the different transfer functions associated with the same covariate or the same combination of covariates. Each of these clusters at the bottom of the hierarchy includes a single transfer function.

Using the hierarchies built by the clustering module 110, the selection module 115 selects a transfer function for each of the transfer functions of the original models 135. The model generation module 120 then replaces the transfer functions of the original models with the transfer functions selected by the selection module 115 in order to build the new models 150.

An example of traversing a hierarchy to find a set of transfer functions that will replace the transfer functions of the original models will now be described by reference to FIG. 2. To select transfer functions, the selection module 115 in one embodiment of the invention traverses the hierarchy of clusters 200 from the top of the hierarchy towards the bottom of the hierarchy until a desired accuracy is achieved. In one embodiment of the invention, the selection module 110 achieves the desired accuracy when the differences between the target variable values transformed by the replaced transfer functions and the corresponding target variable values transformed by the original transfer functions before being replaced is within a threshold value.

In one embodiment of the invention, the selection module 115 identifies one of the transfer functions in a particular cluster as the transfer function that represents the particular cluster. The selection module 115 computes the target variable values for those models that have the transfer functions that belong to the particular cluster, by transforming the values of the covariates of each of the transfer functions into the target variable values. The selection module 115 then designates the transfer function that results in the least amount of difference between the transformed values and the corresponding values transformed by the original transfer functions as a representative transfer function of the particular cluster.

For the simplicity of description, assume that the cluster 205 at top of the hierarchy 200 has three transfer functions ƒ_{9,3}, ƒ_{9,4}, and ƒ_{9,5} that are associated with the same covariate X₉. The three transfer functions are of the original models 3, 4, and 5, respectively. The selection module 115 replaces ƒ_{9,3}, ƒ_{9,4}, and ƒ_{9,5} in the original models with ƒ_{9,3} and computes the target variables values. The cluster module 110 then compares these target variable values with the target variable values that are computed by the models 3, 4, and 5 without having the transfer functions ƒ_{9,3}, ƒ_{9,4}, and ƒ_{9,5} replaced with ƒ_{9,3}, in order to calculate the difference in the target variable values. The cluster module 110 repeats the computation and comparison for ƒ_{9,4}, and ƒ_{9,5} and then identifies the transfer function that results in the least amount of differences in the target variable values as the representative transfer function of the cluster.

Once a representative transfer function is designated for the cluster 205, the selection module 115 compares (1) the target variable values resulting from replacing all of the transfer functions of the original models that belong to the cluster 205 with the representative transfer function and (2) the target variable values resulting from the original transfer functions before being replaced. When the comparison results in differences in the target variable values within a desired threshold value, the selection module 115 selects the representative transfer function and does not further move down on the hierarchy 200.

When the comparison does not result in differences in the target variable values within the desired threshold value, the selection module 115 moves down to a next lower level of the hierarchy of clusters 200. For instance, at the next lower level of the hierarchy 200, two clusters of the transfer functions exist and thus two transfer functions would represent all of the different transfer functions of the original models. That is, each of the different transfer functions of the original model belongs to one of the two clusters of the transfer functions at this level of the hierarchy 200. The selection module 115 repeats the designation of a representative transfer function and the comparison of the target variable values for each of these two clusters at this level of the hierarchy.

Whether to move down further on the hierarchy 200 is separately determined for the two clusters. That is, when the representative transfer function for one of the two clusters satisfies the desired threshold value, the selection module 115 selects this representative transfer function to replace all of the transfer functions of the original models that belong to this cluster and stops moving further down on the hierarchy. When the representative transfer function for one of the two clusters do not satisfy the desired threshold value, the selection module 115 moves down on the hierarchy along the branch that originates from this cluster.

In this manner, the selection module 115 “prunes” the tree representing the hierarchy 200, thereby reducing the number of different transfer functions associated with the same covariate or the same combination of covariates in the models. The selection module 115 repeats this pruning process for all of the hierarchies 140 created by the clustering module 110 for all of the covariates and combinations of covariates in the model equation. As such, the selection module 115 reduces a large number of different transfer functions of the original models to a manageable number of different transfer functions.

In one embodiment of the invention, the selection module 115 takes as an input from the user the desired threshold value. Alternatively or conjunctively, the selection module 115 takes as an input from the user a desired number of different transfer functions. The selection module 115 uses this desired number of different transfer functions to determine how far down on each hierarchy the selection module 115 traverses for the original models. For instance, the selection module 115 moves down to a level of each hierarchy at which the number of clusters is the desired number divided by the number of the original modeling tasks 130.

In one embodiment of the invention, the selection module 115 is configured to have the desired threshold value and/or the desired number of different transfer functions predefined. That is, in this embodiment of the invention, the selection module 115 is configured to select transfer functions automatically without taking user inputs.

The selection module 115 provides the selected transfer functions 145 to the model generation module 120. In one embodiment of the invention, each of the selected transfer functions 145 indicates which transfer function(s) of the original models 130 to replace. The model generation module 145 generates the new models 150 by replacing the transfer functions of the original models 130 with the selected transfer functions 145.

The forecasting module 125 generates the forecasting results 155 by forecasting target variable values of the modeling tasks 130 using the new models 150. In an embodiment of the invention, the forecasting module 125 is an optional module of the system 100. That is, the system 100 may not perform the forecasting for the target variable values and stops at building the new models 150. The new models 150 would be available for other analysis such as regression and classification (where the transfer functions in the new models may represent the separating surface between two classes of modeling tasks). For instance, queries along the lines of “how many models use transfer function T35 for the second covariate” or “show all models that use transfer function T98,” etc., may be conducted.

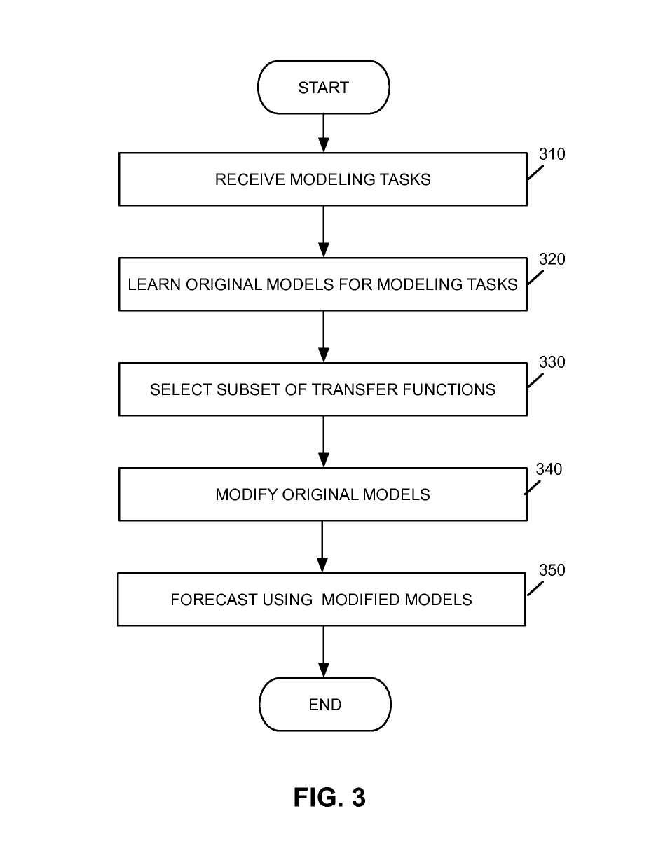

FIG. 3 is a flow chart depicting a method for building a set of understandable models in accordance with an embodiment of the invention. At block 310, the method receives a set of modeling tasks. As described above, a modeling task includes a set of time series data of the target variable and the covariates based on which forecasting on the target variable values are made. The received modeling tasks have the same number of covariates, and the types of covariates of the received modeling tasks are the same. As a simplified example, the method receives three modeling tasks for forecasting household energy consumption in three regions based on the effects of wind speeds and temperatures in the respective regions of the household.

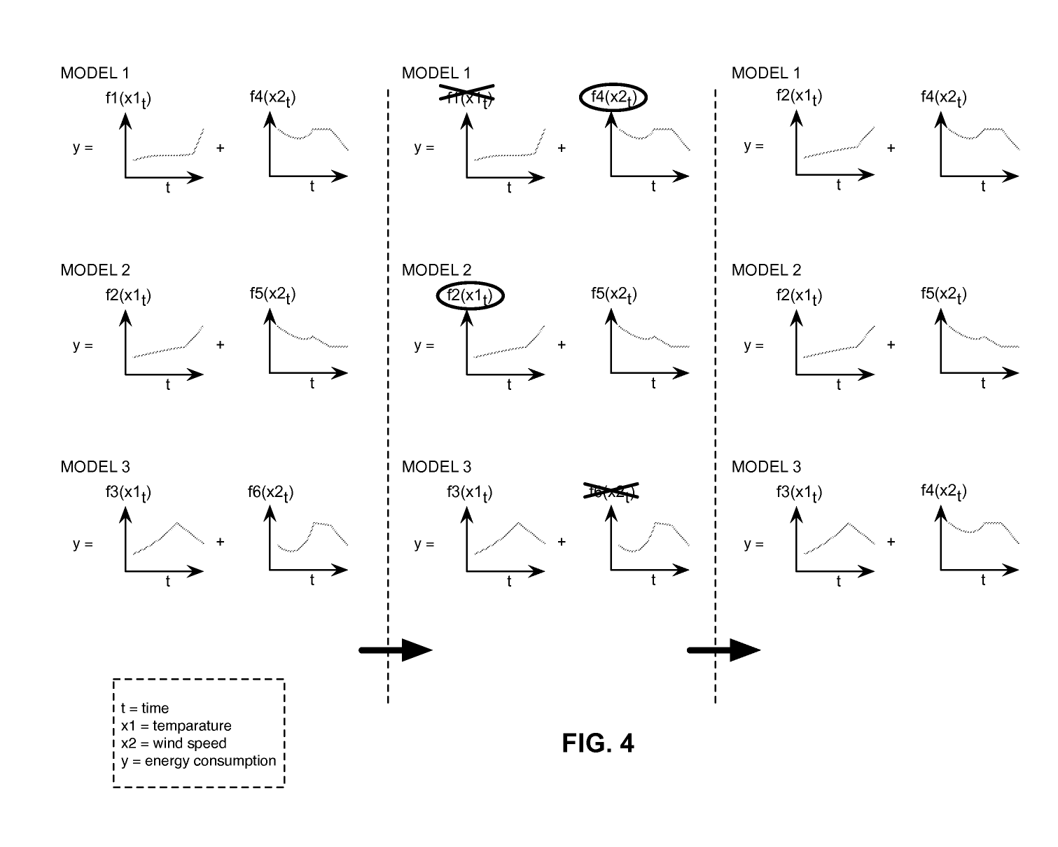

At block 320, the method learns an original model for each of the modeling tasks received at block 310. In an embodiment of the invention, the method learns the original models by utilizing the model equation and solving the optimization problem described above. Each of the original models has a set of transfer functions. Each transfer function is associated with a covariate or a combination of covariates. In the household energy consumption example, the method generates three original models 1, 2 and 3 as shown in the left column of FIG. 4. Each of the three original models has two transfer functions—f1 and f4 for the model 1, f2 and f5 for the model 2, and f 3 and f6 for model 6. As shown, the six transfer functions are mutually different.

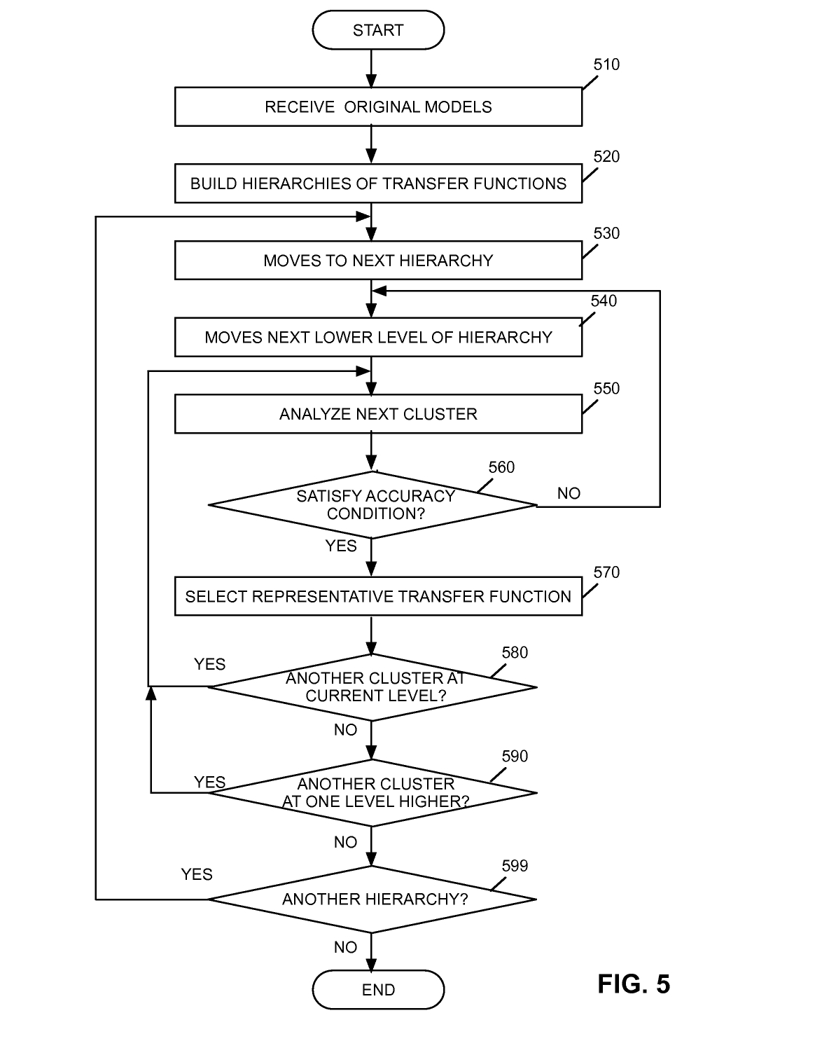

Referring again to FIG. 3, the method at block 330 then selects a subset of the transfer functions of the original models in order to reduce the number of different transfer functions learned from the modeling tasks. In one embodiment of the invention, the method selects the subset such that models built from the original models by replacing the transfer functions of the original models with the selected subset maintain a certain level of accuracy compared to the original models. An example method for selecting a subset of the transfer functions of the original models will be described further below by reference to FIG. 5. Referring to FIG. 4 for the household energy example, the method selects four transfer functions f2, f3, f4, and f5 as shown in the middle column of FIG. 4. More specifically, the method selects f2 over f1 that is similar to f2 and selects f4 over f6 that is similar to f4.

Referring back to FIG. 3, the method at block 340 modifies the original models by replacing each of the transfer functions of the original models with one of the transfer functions selected at block 330. In the household energy consumption example, the method modifies the model 1 by replacing f1 with f2 and modifies the model 3 by replacing f6 with f4 as shown in the right column of FIG. 4. At block 350, the method optionally makes forecasts for the modeling tasks using the updated models.

FIG. 5 is a flow chart depicting a method for selecting a subset of transfer functions of a set of original models learned from a set of modeling tasks according to one embodiment of the invention. At block 510, the method receives a set of original models. Each of the original models has one or more different transfer functions that are used to transform the covariate values into the target variable values. Each of the transfer functions is associated with a covariate or a combination of two or more covariates.

At block 520, the method normalizes and clusters the different transfer functions of the original models hierarchically. Specifically, the method groups those transfer functions that are associated with the same covariate or the same combination of covariates into clusters of similar transfer functions. The method may employ one or more known clustering techniques to cluster the transfer functions to generate a hierarchy of clusters in which smaller clusters merge together to create the next higher level of clusters. The method generates a hierarchy for each set of transfer functions that is associated with the same covariate or the same combination of covariates. That is, the method generates as many such hierarchies as the number of different transfer functions in the model equation.

At block 530, the method moves to a next hierarchy of clusters of transfer functions that is associated with a covariate or a combination of covariates. At block 540, the method moves down to a next lower level in the hierarchy and identifies all of the clusters at this level of the hierarchy. When the method initially moves to a hierarchy, the next lower level is the top level of the hierarchy where one cluster includes all of the different transfer functions associated with a covariate or a combination of covariates.

At block 550, the method analyzes a next cluster of the clusters at the current level of the hierarchy. In one embodiment of the invention, the method identifies one of the transfer functions in the cluster as the transfer function that represents the particular cluster. The method computes the target variable values for those models that have the transfer functions that belong to this cluster, by transforming the values of the covariates of each of the transfer functions into the target variable values. The method then designates the transfer function that results in the least amount of difference between the transformed values and the corresponding values transformed by the original transfer functions as a representative transfer function of this cluster.

At decision block 560, the method determines whether the cluster satisfies an accuracy condition. In one embodiment of the invention, the method compares (1) the target variable values (or, the mean target variable value) resulted from replacing all of the transfer functions of the original models that belong to the cluster with the representative transfer function and (2) the target variable values (or, the mean target variable value) resulted from the original transfer functions before being replaced. When the comparison results in a difference in the target variable values within a desired threshold value, the method determines that the cluster satisfies the accuracy condition. Otherwise, the method determines that the cluster does not satisfy the accuracy condition.

When the method determines at decision block 560 that the cluster does not satisfy the accuracy condition, the method loops back to block 540 to move to the next lower level of the hierarchy along the branch that originates from this cluster. When the method determines at decision block 560 that the cluster satisfies the accuracy condition, the method proceeds to block 570 where it stops moving down the hierarchy (i.e., prunes the branch that originates from this cluster) and selects the representative transfer function for this cluster.

At decision block 580, the method determines whether there is another cluster at the current level of the hierarchy that has not yet been analyzed. When the method determines that there is such cluster at the current level, the method loops back to block 550 to analyze the cluster. Otherwise, the method proceeds to decision block 590 to determine whether there is a cluster that has not yet been analyzed at the level that is one level higher than the current level. When the method determines at decision block 590 that there is such cluster at the higher level, the method loops back to block 550 to analyze the cluster.

At decision block 599, the method determines whether there is another hierarchy that has not yet been traversed. When the method determines that there is another hierarchy, the method loops back to block 530 to traverse the hierarchy.

An alternative embodiment of the invention provides a method of building models for a large number of related, but not identical modeling tasks based on a user input indicating which of the models for the modeling tasks should share one or more identical transfer functions. The method does not learn models from the modeling tasks and select a subset of transfer functions in order to reduce the number of different transfer functions. Instead, the method uses the user input to generate a reduced number of different transfer functions. In one embodiment, the user input is provided by domain experts who are knowledgeable of the relationship between covariates (e.g., temperature, wind speed, etc.) and a target variable (e.g., energy load on a substation of a utility company).

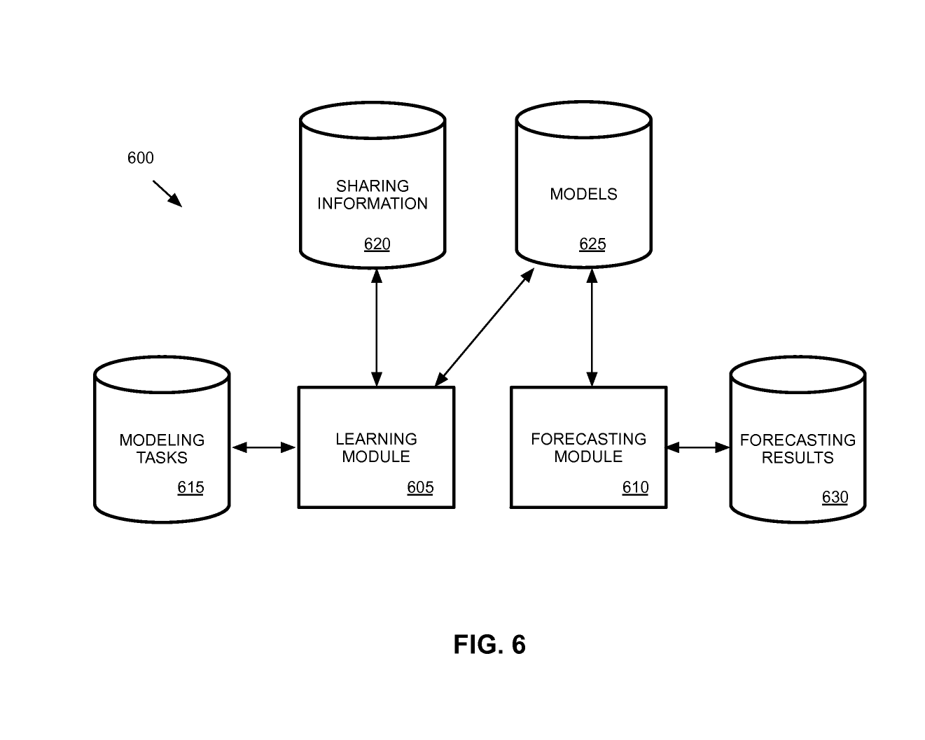

FIG. 6 is a schematic diagram of a modeling system 600 for building models according to an embodiment of the invention. As shown, the system 600 includes a learning module 605 and a forecasting module 610. The system 600 also includes modeling tasks 615, sharing information 620, models 625, and forecasting results 630.

The modeling tasks 615 include sets of time series data. Each set of time series data represents the values of a target variable observed over a period of time. A modeling task also includes the values of input variables observed over the same period of time. The system 600 builds models that may be used for forecasting future values of the target variable based on these previously observed values.

In one embodiment of the invention, the sharing information 620 is a set of constraints imposed by users on the models to be built for the modeling tasks 615. Specifically, each of the constraint indicates which of the models should share one or more identical transfer functions. In one embodiment of the invention, domain experts provide the sharing information.

The learning module 605 analyzes the modeling tasks 615 to learn the models 625. Each of the models 625 may be used for forecasting the values of the target variable of a modeling task 615. Like the learning module 105 described above by reference to FIG. 1, the learning module 605 may utilize one or more known modeling techniques and the AM equation to learn the models 625. However, instead of learning different models having different transfer functions as the learning module 105 does, the learning module 605 learns the models by applying the set of constraints 620 such that the models share one or more identical transfer functions. In this manner, the learning module 605 reduces the number of different transfer functions in the models without clustering the transfer functions and selecting a subset of transfer functions using the cluster.

For the models identified in each of the set of constraints 620, the learning module 605 of one embodiment of the invention jointly learns the models. Specifically, the learning module 605 merges the modeling tasks and then learns these models from the merged modeling tasks. For instance, two modeling tasks may be learned using the following two model equations:

$${M}_{1} : {Y}_{1} ≅ {\sum }_{i = 1}^{I} X {1}_{i , 1} + {\sum }_{j = 1}^{J} {f}_{j , 1} ( X {2}_{j , 1} \vert {C}_{j , 1} ) + {\sum }_{k = 1}^{K} {g}_{k , 1} ( X {3}_{k , 1} , X {4}_{k , 1} \vert {C}_{k} )$$

$${M}_{2} : {Y}_{2} ≅ {\sum }_{i = 1}^{I} X {1}_{i , 2} + {\sum }_{j = 1}^{J} {f}_{j , 2} ( X {2}_{j , 2} \vert {C}_{j , 2} ) + {\sum }_{k = 1}^{K} {g}_{k , h} ( X {3}_{k , 2} , X {4}_{k , 2} \vert {C}_{k} )$$

Assuming, as an example, that a particular constraint indicates that the transfer function ƒ_{1,1}(X2_{1,1}|C₁) in the model equation M₁ should be identical to the transfer function ƒ_{1,2}(X2_{1,2}|C₁) in the model equation M₂. In other words, the constraint indicates that the transfer function ƒ₁ that is associated with a covariate X2₁ should be shared by the models being learned from the modeling tasks 1 and 2. Then, the learning module 605 may learn the two models by solving the following joined optimization problem:

min(μ₁×Term_{M}_{₁}+μ₂×Term_{M}_{₂}+μ_{constraint}×Term_{similarity}_{_{—}}_{constraint})

where:

$${Term}_{{M}_{1}} = {‖ {Y}_{1} - ( {\sum }_{i = 1}^{I} X {1}_{i , 1} + {\sum }_{j = 1}^{J} {f}_{j , 1} ( X {2}_{j , 1} \vert {C}_{j} ⋂ data\_set == 1 ) + {\sum }_{k = 1}^{K} {g}_{k , 1} ( X {3}_{k , 1} , X {4}_{k , 1} \vert {C}_{k , joined} ) ) ‖}^{2} - {Pen}_{1}$$

$${Term}_{{M}_{2}} = {‖ {Y}_{2} - ( {\sum }_{i = 1}^{I} X {1}_{i , 2} + {\sum }_{j = 1}^{J} {f}_{j , 2} ( X {2}_{j , 2} \vert {C}_{j} ⋂ data\_set == 2 ) + {\sum }_{k = 1}^{K} {g}_{k , 2} ( X {3}_{k , 2} , X {4}_{k , 2} \vert {C}_{k , joined} ) ) ‖}^{2} - {Pen}_{2}$$

$${Term}_{similarity \_ constraint} = {‖ {f}_{1 , 1} ( X {2}_{1 , 1} \vert {C}_{1} ) - {f}_{1 , 2} ( X {2}_{1 , 2} \vert {C}_{1} ) ‖}^{2}$$

where Term_{M}_{₁} is for fitting the model M₁ as closely as possible to the modeling tasks 1's data set D₁ and Term_{M}_{₂} is for fitting the model M₁ as closely as possible to the modeling tasks 2's data set D₂. The data sets D1 and D2 are:

D₁=[X1_{1,1}˜X1_{I,1},X2_{1,1}˜X2_{J,1},X3_{1,1}˜X3_{K,1},X4_{1,1}˜X4_{K,1},Y₁]

D₂=[X1_{1,2}˜X1_{I,2},X2_{1,2}˜X2_{J,2},X3_{1,2}˜X3_{K,2},˜X4_{1,2}˜X4_{K,2},Y₂]

Term_{simliarity}_{_{—}}_{constraint} penalizes the models for the difference between the function ƒ_{1,1}(X2_{1,1}|C₁) in the model equation M₁ and the function ƒ_{1,2}(X2_{1,2}|C₁) in the model equation M₂. The parameters μ₁, μ₂, and μ_{constraint} are weights assigned to Term_{M}_{₁}, Term_{M}_{₁}, and Term_{similarity}_{_{—}}_{constraint}, respectively, for balancing the accuracy criteria of each of the models M₂ and M₂ and the function similarity criteria.

The joined optimization problem is trained on a combined data set D_{1∪2} with an indicator that is added to indicate the source data set for a data point. The combined data set may be in the following form:

$${D}_{1 ⋃ 2} = [ \begin{matrix}X {1}_{1 , 1} \sim X {1}_{I , 1} , X {2}_{1 , 1} \sim X {2}_{J , 1} , X {3}_{1 , 1} \sim X {3}_{K , 1} , X {4}_{1 , 1} \sim X {4}_{K , 1} , {Y}_{1} , data\_set = 1 \\ X {1}_{1 , 2} \sim X {1}_{I , 2} , X {2}_{1 , 2} \sim X {2}_{J , 2} , X {3}_{1 , 2} \sim X {3}_{K , 2} , X {4}_{1 , 2} \sim X {4}_{K , 2} , {Y}_{2} , data\_set = 2\end{matrix} ]$$

In Term_{M}_{₁} and Term_{M}_{₂} of the joined optimization problem, the conditions Cⱼ and Cₖ for the transfer functions ƒⱼ and θₖ are extended with the source data set indicator data_set in order to ensure that the transfer functions of a given model are active only for the data points for the given model.

In a similar manner, the learning module 605 may join three or more models with one or more constraints. The joined optimization problem for three or more models having a common transfer function may be in the following form:

$$min ( {\sum }_{h = 1}^{H} {μ}_{h} {Term}_{{M}_{h}} + {\sum }_{l = 0}^{L} {μ}_{constraint} {Term}_{similarity \_ constraint} )$$

where H is the number of models, and L (a positive integer) is the number of different constraints.

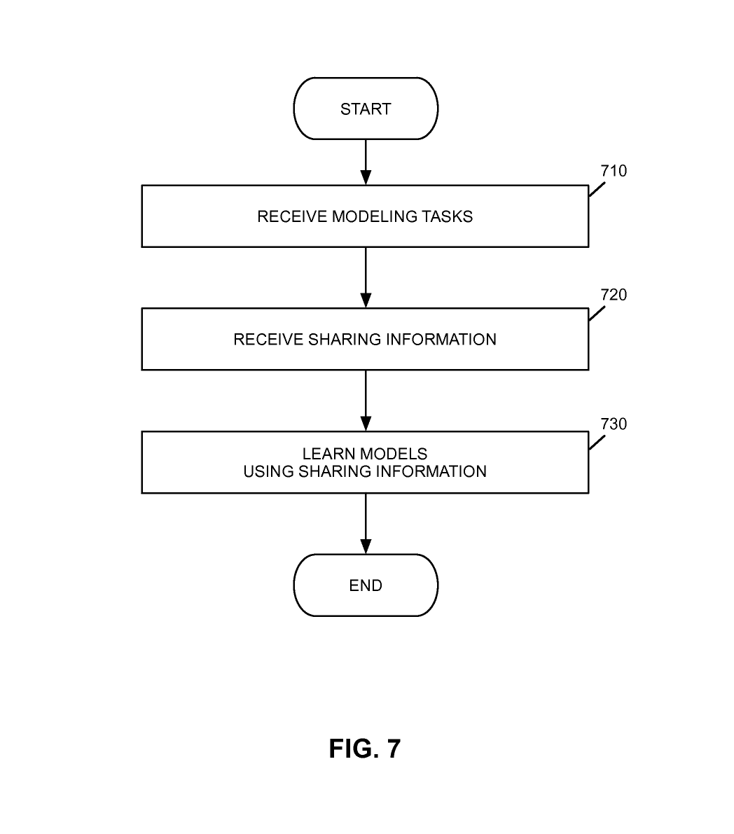

FIG. 7 is a flow chart depicting a method for building a set of understandable models in accordance with an embodiment of the invention. At block 710, the method receives a set of modeling tasks. As described above, a modeling task includes a set of time series data of the target variable and the covariates based on which forecasting on the target variable values may be made. The received modeling tasks have the same number of covariates, and the types of covariates of the received modeling tasks are the same. As a simplified example, the method receives three modeling tasks for modeling household energy consumption in three regions based on the effects of wind speeds and temperatures in the respective regions of the household.

At block 720, the method receives sharing information (e.g., a set of constraints) indicating which of the models for the modeling tasks should share one or more identical transfer functions. In one embodiment of the invention, the method receives the sharing information from user(s), e.g., domain experts who are knowledgeable of the relationship between covariates and a target variable. Alternatively or conjunctively, the method receives the sharing information from a modeling system (e.g., the modeling system 100 described above by reference to FIG. 1) that clusters and selects transfer functions and thus knows which models for which modeling tasks should share identical transfer function(s).

In the household energy consumption example, the method would generate three models 1, 2 and 3 each of which have two transfer functions associated with the two covariates—temperature and wind speed. A domain expert provides sharing information indicating that a transfer function associated with the temperature should be identical for the models 1 and 2 and a transfer function associated with the wind speed should be identical for the models 1 and 3. That is, there are four different transfer functions for the method to learn instead of six different transfer functions that would have been learned without the sharing information provided by the domain expert.

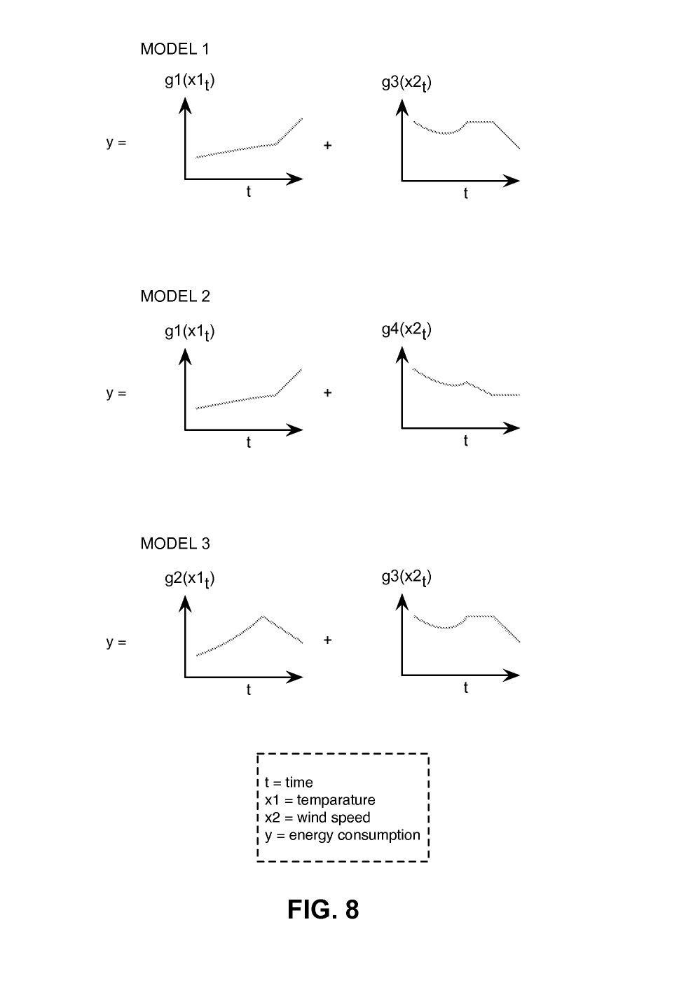

At block 730, the method learns models from those modeling tasks by applying the sharing information. For the models identified by the sharing information, the method formulates a joined optimization problem by joining several optimization problems for learning the models individually. The method also joins the data sets of the modeling tasks from which the models to be learned. The method then learns the models by solving the joined optimization problem based on the joined data set. FIG. 8 shows the result of learning the models 1, 2 and 3 in the household energy consumption example. Based on the information provided by the domain expert at 720, the method learns four different transfer functions g1-g4 simultaneously.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described above with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one more other features, integers, steps, operations, element components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated

The flow diagrams depicted herein are just one example. There may be many variations to this diagram or the steps (or operations) described therein without departing from the spirit of the invention. For instance, the steps may be performed in a differing order or steps may be added, deleted or modified. All of these variations are considered a part of the claimed invention.

While the preferred embodiment to the invention had been described, it will be understood that those skilled in the art, both now and in the future, may make various improvements and enhancements which fall within the scope of the claims which follow. These claims should be construed to maintain the proper protection for the invention first described.

1. A computer program product for generating models for a plurality of modeling tasks, the computer program product comprising a computer readable storage medium having stored thereon:
first program instructions executable by a processor to cause the processor to receive the modeling tasks each having a target variable and at least one covariate, the target variable and the at least one covariate being the same for all of the modeling tasks, a relationship between the target variable and the at least one covariate being different for all of the modeling tasks; and
second program instructions executable by the processor to cause the processor to generate, for each of the modeling tasks, a model including a transfer function for approximating the relationship between the target value and the at least one covariate of the modeling task in a manner that at least two of the models share at least one identical transfer function and the models satisfy an accuracy condition.

2. The computer program product of claim 1, wherein the second program instructions comprise:
third program instructions executable by the processor to cause the processor to learn the transfer functions from the modeling tasks such that the transfer functions are different for all of the models;
fourth program instructions executable by the processor to cause the processor to select a subset of the transfer functions; and
fifth program instructions executable by the processor to cause the processor to modify the models by replacing the transfer functions of the models with the subset of the transfer functions.

3. The computer program product of claim 2, wherein the fourth program instructions comprise:
sixth program instructions executable by the processor to cause the processor to group the transfer functions into a plurality of clusters of transfer functions based on similarities of the transfer functions;
seventh program instructions executable by the processor to cause the processor to identify a transfer function in each of the clusters to represents the cluster; and
eighth program instructions executable by the processor to cause the processor to select a set of the representative transfer functions that satisfies the accuracy condition.

4. The computer program product of claim 3, wherein the accuracy condition is satisfied when values approximated by a representative transfer function of a cluster is within a threshold difference from values approximated by a particular transfer function of a model to be replaced by the representative transfer function.

5. The computer program product of claim 2 further comprising third program instructions executable by the processor to cause the processor to forecast target variable values for a particular modeling task using the modified model for the particular modeling task.

6. The computer program product of claim 1 further comprising third program instructions executable by the processor to cause the processor to receive the accuracy condition from a user.

7. The computer program product of claim 1, wherein the second program instructions comprise:
third program instructions executable by the processor to cause the processor to receive, from a user, an input indicating which of the models should share the at least one identical transfer function; and
fourth program instructions executable by the processor to cause the processor to generate the plurality of models based on the input.

8. A system for generating models for a plurality of modeling tasks, the system comprising a processor configured to:
receive the modeling tasks each having a target variable and at least one covariate, the target variable and the at least one covariate being the same for all of the modeling tasks, a relationship between the target variable and the at least one covariate being different for all of the modeling tasks; and
generate, for each of the modeling tasks, a model including a transfer function for approximating the relationship between the target value and the at least one covariate of the modeling task in a manner that at least two of the models share at least one identical transfer function and the models satisfy an accuracy condition.

9. The system of claim 8, wherein the processor is further configured to receive, from a user, an input indicating which of the models should share the at least one identical transfer function and to generate the models based on the input.

10. The system of claim 8, wherein each of the modeling tasks has a data set that includes values of the at least one covariate and values of the target variable, wherein the processor is configured to generate the models further by learning the models simultaneously from the data sets corresponding to the models.

11. The system of claim 10, wherein the learning comprises:
formulating an optimization problem by joining the models;
joining data sets corresponding to the models; and
fitting the models into the joined data sets by solving the optimization problem based on the joined data sets.

12. The system of claim 11, wherein the solving the optimization problem comprises minimizing difference between the target variable values and values approximated by the transfer function.

13. The system of claim 8, wherein the processor is further configured to forecast target variable values for a particular modeling task using the model for the particular modeling task.

14. The system of claim 8, wherein the processor is configured to generate the models by:
learning the transfer functions from the modeling tasks such that the transfer functions are different for all of the models;
selecting a subset of the transfer functions; and
modifying the models by replacing the transfer functions of the models with the subset of the transfer functions.

15-20. (canceled)
